(19) United States
(12) Patent Application Publication
(10) Pub. No.: US 2013/0096710 A1
(43) Pub. Date: Apr. 18, 2013

(54) TRACKING SYSTEM AND METHOD FOR SOLAR CELL MANUFACTURING

(71) Applicants: Mustafa Pinarbasi, Morgan Hill, CA (US); Howard Zolla, Los Gatos, CA (US); Serkan Erdemli, San Jose, CA (US)

(72) Inventors: Mustafa Pinarbasi, Morgan Hill, CA (US); Howard Zolla, Los Gatos, CA (US); Serkan Erdemli, San Jose, CA (US)

(73) Assignee: SoloPower, Inc., San Jose, CA (US)

(21) Appl. No.: 13/275,243

(22) Filed: Oct. 17, 2011

(51) Int. Cl. G06F 19/00

(52) U.S. Cl. 700/108

(57) ABSTRACT

A system and method of manufacturing solar panels whereby parameters about how each cell, each array and each panel are recorded in a database or electronic memory. The cells, arrays and panels are also provided an identification, such as a bar code, to allow for subsequent retrieval of the parameters. The electronic memory is arranged so that different cells, arrays and panels that share the same parameters can be identified.

### BACKGROUND OF THE INVENTION

1. Field of the Invention

The present invention relates to solar cells and, in particular, concerns a system and method for manufacturing thin film solar cells whereby manufacturing details and parameters for individual cells, strings of cells and solar panels can be maintained for future product assessment and manufacturing optimization based on subsequent performance in the field.

2. Description of the Related Art

Solar cells are photovoltaic (PV) devices that convert sunlight directly into electrical energy. Solar cells can be based on crystalline silicon or thin films of various semiconductor materials, that are usually deposited on low-cost substrates, such as glass, plastic, or stainless steel.

Thin film based photovoltaic cells, such as amorphous silicon, cadmium telluride, copper indium diselenide or copper indium gallium diselenide based solar cells, offer improved cost advantages by employing deposition techniques widely used in the thin film industry. Group IBIIIAVIA compound photovoltaic cells including copper indium gallium diselenide (CIGS) based solar cells have demonstrated the greatest potential for high performance, high efficiency, and low cost thin film PV products.

As illustrated in FIG. 1, a conventional Group IBIIIAVIA compound solar cell 10 can be built on a substrate 11 that can be a sheet of glass, a sheet of metal, an insulating foil or web, or a conductive foil or web. A contact layer 12 such as a molybdenum (Mo) film is deposited on the substrate as the back electrode of the solar cell. An absorber thin film 14 including a material in the family of Cu(In,Ga)(S,Se)₂, is formed on the conductive Mo film. The substrate 11 and the contact layer 12 form a base layer 13. Although there are other methods, Cu(In,Ga)(S,Se)₂ type compound thin films are typically formed by a two-stage process where the components (components being Cu, In, Ga, Se and S) of the Cu(In,Ga)(S,Se)₂ material are first deposited onto the substrate or the contact layer formed on the substrate as an absorber precursor, and are then reacted with S and/or Se in a high temperature annealing process.

After the absorber film 14 is formed, a transparent layer 15, for example, a CdS film, a ZnO film or a CdS/ZnO film-stack, is formed on the absorber film 14. Light enters the solar cell 10 through the transparent layer 15 in the direction of the arrows 16. The preferred electrical type of the absorber film is p-type, and the preferred electrical type of the transparent layer is n-type. However, an n-type absorber and a p-type window layer can also be formed. The above described conventional device structure is called a substrate-type structure. In the substrate-type structure light enters the device from the transparent layer side as shown in FIG. 1. A so called superstrate-type structure can also be formed by depositing a transparent conductive layer on a transparent superstrate such as glass or transparent polymeric foil, and then depositing the Cu(In,Ga)(S,Se)₂ absorber film, and finally forming an ohmic contact to the device by a conductive layer. In the superstrate-type structure light enters the device from the transparent superstrate side.

In standard CIGS as well as Si and amorphous Si module technologies, the solar cells can be manufactured on flexible conductive substrates such as stainless steel foil substrates. Due to its flexibility, a stainless steel substrate allows low cost roll-to-roll solar cell manufacturing techniques. In such solar cells built on conductive substrates, the transparent layer and the conductive substrate form the opposite poles of the solar cells. Multiple solar cells can be electrically interconnected by stringing or shingling methods that establish electrical connection between the opposite poles of the solar cells. Such interconnected solar cells are then packaged in protective packages to form solar modules or panels. Many modules can also be combined to form large solar panels. The solar modules are constructed using various packaging materials to mechanically support and protect the solar cells contained in the packaging against mechanical damage. Each module typically includes multiple solar cells which are electrically connected to one another using the above mentioned stringing or shingling interconnection methods.

It will, thus, be appreciated that the construction of solar cells, both crystalline silicon solar cells and thin film solar cells such as those described above is a complex process involving multiple different processing steps. Multiple different deposition steps followed by reaction steps are used to create the various layers of the solar cells. At each step of the manufacturing process, there are multiple different manufacturing parameters that affect the overall quality of the cells and the cells resultant performance. Very small changes in temperature, ambient pressure, gas pressure, composition etc. can result in differing performance of the solar cells over time.

Changes in the parameters of manufacturing solar panels that can result in changes in long term performance are not just limited to changes in the manufacturing of the cells themselves. When the cells are interconnected into strings, parameters such as the type of connection, the materials used, junction box configuration, front and back sheet materials, laminates used and the environmental factors occurring when the panel was made may all affect the long term performance of the product. Further, when the strings are assembled into panels, various parameters relating to the panel may also significantly impact the overall performance of the panel.

Various other factors that relate to solar panels may also have a long term effect on the performance of the solar panel. For example, the age of the panel, the manner in which it was stored, the environment in which it was installed may all have an affect on the overall performance of the panel.

Typically, solar cells are being manufactured for long term use. It is expected that panels may be continuously used for multiple decades. It may also be that various manufacturing, assembly and use parameters of solar panels may affect solar panel performance and that these effects may not become apparent for many years after the panel has been manufactured. Currently, panels are manufactured and there is little effort to capture and store manufacturing, assembly and use parameters that can be used to evaluate long term performance of panels.

As a result, optimizing manufacturing, assembly and use parameters of solar panels for long term use cannot generally be performed as a result of not sufficiently capturing the data at the initial stages of panel manufacturing and assembly. Hence, there is a need for a system and process of manufacturing, assembly and distributing solar panels that capture parameters and data that will be helpful in evaluating long term performance of solar panels.

### SUMMARY OF THE INVENTION

The aforementioned needs are satisfied by various embodiments of the methods and systems of manufacturing solar cells of the present invention. In one embodiment, a method of manufacturing a solar panel or array is provided. In this embodiment, the cells are identified and the parameters for one or more of the manufacturing steps of the solar cells are captured and recorded in a memory. This embodiment can further include steps whereby parameters relating to the assembly of the cells into elements such as strings and arrays are also captured. This embodiment can further include steps whereby parameters associated with the manufacturing of the elements into a panel suitable for installation can also be captured. This embodiment can further include steps whereby parameters associated with where the panels are installed in the field can also be captured.

By capturing some or all of these parameters, the long term performance of the solar cells, arrays and panels can be more carefully monitored. For example, degradation of the performance of panels in a particular environment may be traceable to a manufacturing parameter which can then be used to alter this parameter in future panels. Further, significant defects in device performance may also only become apparent and traceable to particular manufacturing, assembly or use parameters after long term use and being able to track defects to particular recorded parameters may allow the solar panel manufacturer to advise other end users of panels of potential problems with their panels.

In another embodiment, the invention is a system that applies identification information to the solar cells during manufacturing, to the arrays of solar cells and to the panels during assembly. The system further captures manufacturing and assembly parameters and stores these parameters. In one specific implementation, these parameters are stored in relational database structures that can allow for correlation between related cells, arrays and panels so that panels, arrays and cells with similar parameters can be identified and compared.

In one aspect the aforementioned needs are satisfied by a method of manufacturing a solar cell. The method comprises forming an absorber layer of the solar cell on a substrate and recording parameters about the forming of the absorber layer in an electronic memory device. The method further comprises forming a transmissive layer on the absorber layer recording parameters about the forming of the transmissive layer in the electronic memory device marking the solar cell with identification information. The method further comprises correlating the recorded parameters with the identification information in the electronic memory device such that the identification information can be used to subsequently electronically retrieve the recorded parameters from the electronic memory device.

The aforementioned needs are also met in another aspect by a method of manufacturing solar cell panels. The method comprises manufacturing a plurality of solar cells and assigning identification information to each of the plurality of solar cells. The method further comprises recording solar cell parameters in an electronic memory so that the parameters for a particular solar cell are retrievable by the identification information and interconnecting at least some of the plurality of solar cells into one or more arrays of solar cells and assigning identification information to each of the arrays of solar cells. The method further comprises recording array parameters in an electronic memory so that the parameters for a particular array are retrievable by the identification information of the array of solar cells and so that the identification information and parameters of the solar cells comprising the array is retrievable from the electronic memory and mounting one or more array of solar cells onto one or more panels so as to create solar panels. The method further comprises assigning identification information to the solar cell panels and recording solar panel parameters in the electronic memory so that the parameters for a particular solar panel are retrievable by the identification information about the solar cell panel and so that the identification information and parameters about the arrays and the solar cells of the arrays is retrievable from the electronic memory

The aforementioned needs are also met in another aspect by a method of roll-to-roll forming a plurality of thin films on a continuous flexible substrate to manufacture solar cells and identifying each manufactured solar cell. In this aspect, the method comprises marking a region of the continuous flexible substrate with at least one identification mark, wherein the at least one identification mark includes an information about the location of the region and forming a solar cell structure over the continuous flexible substrate including the region while the continuous flexible substrate is advanced through at least one process station. In this aspect this method further comprises continuously detecting process information from the region as the solar cell structure is formed over the continuous flexible substrate including the region and as it is advanced and data processing the process information in an electronic data-base station, wherein the data processing comprises storing the process information detected from the region in the electronic database, correlating the process information from the region to the at least one identification mark.

In one implementation of this aspect, the plurality of solar cells are formed by cutting the continuous flexible substrate and each solar cell can then be marked with a solar cell identification mark. The solar cell identification mark can then be stored in the electronic data-base and each solar cell can be correlated to the process information for the region of the substrate from which the solar cell identification mark corresponds.

In another implementation of this aspect, the solar cells are arranged into strings and a string identification mark is formed adjacent the string which is correlated to manufacturing and use information about the string. In another implementation, the strings are arranged into panels and a panel identification mark is formed on the panel which is correlated to manufacturing and use information about the panel.

In another implementation of this aspect, the step of marking the region includes marking a plurality of sections of the region ordered along the length of the continuous flexible substrate with a plurality of identification marks, wherein each of the identification marks correspond to its assigned section along the continuous flexible substrate. In this implementation, the step of data processing the process information includes storing process information from each section of the region in the electronic database and correlating the process information from each section to its corresponding identification mark.

Thus, the various embodiments of the present invention permit the capture of data that can be used to determine the initial parameters of long term performance of solar cells, arrays and panels. These and other objects and advantages of the present invention will become more apparent from the following description taken in conjunction with the accompanying drawings.

### BRIEF DESCRIPTION OF THE DRAWINGS

FIG. 1 is a simplified schematic view of a thin film solar cell;

FIGS. 2A and 2B are a simplified schematic views of a manufacturing line used to produce a thin film solar cell;

FIG. 3 is a schematic view of an exemplary web of solar cells with identification markers on the web;

FIG. 4 is a simplified schematic view of an exemplary solar panel comprising a plurality of arrays of cells with identification markers on the panel, the arrays and the cells; and

FIG. 5 is a simplified flow chart illustrating the manner in which performance parameters of the plurality of solar cells, arrays of solar cells and solar panels are captured.

### DETAILED DESCRIPTION OF THE PREFERRED EMBODIMENT

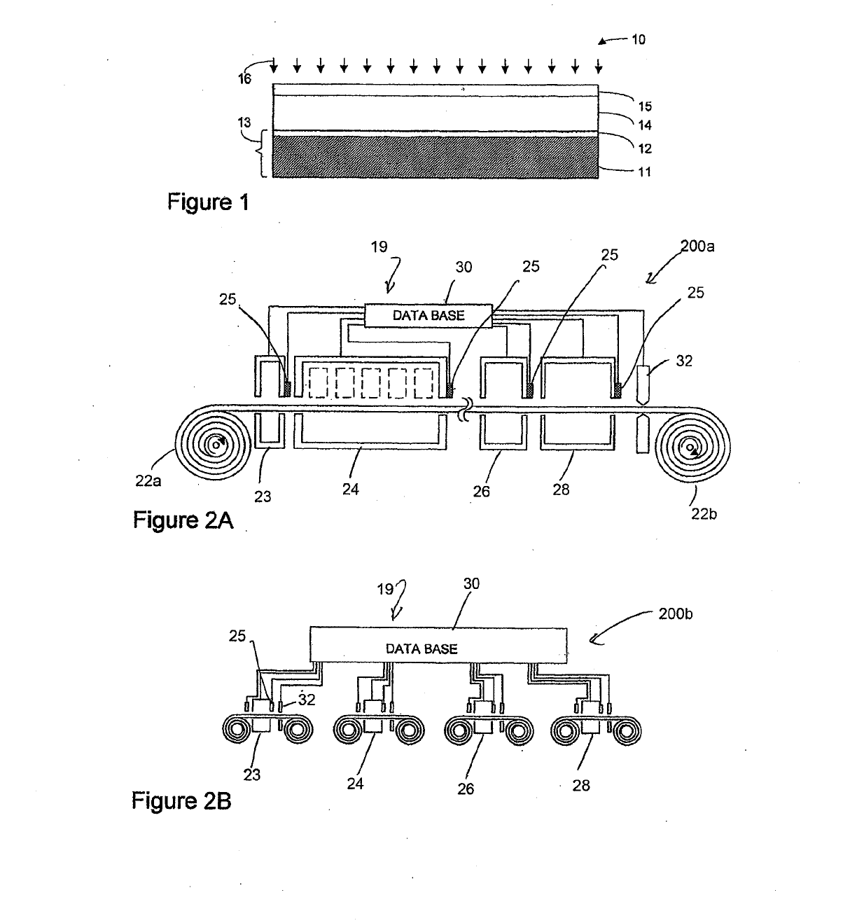

Reference will now be made to the drawings wherein like numerals refer to like parts throughout. Referring initially to FIGS. 2A and 2B, examplary schematics illustrate roll-to-roll systems 200A and 200B, respectively, using a basic roll-to-roll process and production line 19 by which a plurality of thin film solar cells 10 such as conventional Group IBIIIAVIA compound solar cells like those described in connection with FIG. 1, is formed. As shown in FIGS. 2A and 2B, solar cell layers are first formed on a flexible continuous substrate 11 that may be in the form of a web 20 that extends between two rolls 22a and 22b. The web 20 is directed through a plurality of components or process stations of the system 200A or the system 200B to deposit and react the various solar cell layers on the web 20 until the desired solar cell layer structure is produced. The web with the solar cell structure on it is subsequently cut to form the individual solar cells 10 in a subsequent process step. As shown in FIGS. 2A and 2B, in the roll-to-roll system 200A, preferably using a single universal roll to roll moving mechanism, the web 20 may be supplied from the roll 22a, linearly advanced through the process stations and taken out from the system with the solar cell structure on it as the processed roll 22b. In the system 200B, however, process stations 23, 24, 26 and 28 may have individual roll-to-roll mechanisms to form the assigned solar cell layer over the web 20. Accordingly, in the configuration shown in FIG. 2B, the processed roll from the first process station becomes the supply roll of the second process station and so on. Once the web is sequentially processed in all four or more process stations, the last processed roll from the last process station contains the required solar cell layers mentioned above. It will be appreciated that the exact manufacturing steps and components may vary depending upon the solar cells that are being created without departing from the scope of the present invention.

Using the roll-to-roll systems 200A or 200B shown in FIGS. 2A and 2B, the web 20 is initially routed through one or more deposition chambers 23, 24 in which a contact layer 12 and the absorber 14 are formed. In the chamber 23, a contact layer 12, such as molybdenum layer, is initially deposited as a film to a desired thickness. Subsequently, a precursor absorber thin film material 14, which can include materials from the family of Cu, In, Ga and Se, can then be deposited on the contact layer 12 in the deposition chamber 24. Once the precursor layers are formed on the web 20 in the deposition chambers 24, the web 20 is then routed through a reactor 26 wherein the precursor materials 14 are reacted with S and/or Se in a high temperature annealing process to form the Cu(In,Ga)(S,Se)₂absorber layer 14.

It will be appreciated that a variety of different parameters affect the formation of the resultant absorber layer 14. The composition of the materials forming the contact layer 12 and the precursor materials are some examples as well as the temperature, pressure, composition of gases and optical properties and other environmental factors in the deposition chambers 24. Similarly, various parameters in the reaction chamber 26 may also affect the formation and future operation of the absorber layer 14 and can include such things as introduced gases, pressures, temperature, duration etc. that can affect the characteristics of the resultant absorber layer 14. Each of these parameters may result in differing performance of the absorber layer 14 over time and, as will be discussed in greater detail below, for each of the solar cells being formed these parameters are recorded by a database system 30 for storage and subsequent review.

As is also shown in FIGS. 2A and 2B, using one the systems 200A or 200B, once the absorber layer 14 is formed, the web 20 is routed through additional processing chambers 28 where transparent window layers 15, such as CdS film or ZnO film or CdS/ZnO film layers, are deposited onto the absorber layer 14 to complete the formation of the solar cells layers. In each of these additional processing chambers 28, various parameters, materials used, quantities of materials, environmental factors such as temperature, pressure and others may also affect the performance of the resulting solar cells and, in particular the long term performance of such solar cells. As will be discussed in greater detail below, these factors are also recorded by the database system 30 during the production run.

Thus, the roll-to-roll manufacturing systems shown in FIGS. 2A and 2B are capturing a plurality of manufacturing parameters relating to the manufacturing of the solar cells that can be used for process control, process uniformity and product development as well as future evaluation of the solar cells. In order to identify the solar cells to thereby associate the manufacturing parameters with specific solar cells, a marking system 32 is employed. The marking system 32 can mark the substrate or web 20 prior to, during or after the formation of the solar cells 10 provided that individual cells or groups of cells can be identified by the database system 30 to thereby associate the recorded parameters with the appropriate cells.

As is also illustrated in FIGS. 2A and 2B, each of the chambers 24, 26, 28 may also include readers 25, such as, for example, a bar code reader, that read identification marks that are formed on the web 20. It will be appreciated that the web is continuously moving between the two rolls 22a and 22b. Thus, marks that are formed on the web 20 provide an indication of the portion of the web 20 that is transitioning through one of the chambers 24, 26 and 28. The web 20 may be routed between multiple chambers 24, 26 and 28 as shown in FIG. 2A or the web 20 may be extended through each chamber individually as shown in FIG. 2B.

Since the web 20 is continuously moving, the database system 30 must be also to capture the parameters in the chambers 24, 26 and 28 and correlate these parameters with the linear location of the web 20 as detected by the readers 25. In this way, the database system 30 is able to determine the linear portion of the web 20 that is in a chamber at any one time and then associate parameters with the solar cells 10 that are on that linear portion and in a particular chamber at that time.

FIGS. 2A and 2B illustrate that the readers 25 are associated with each chamber. It will, however, be appreciated that fewer readers can be used by knowing the relative location of the solar cells 10 on the web 20 and the location of the various chambers. Thus, once a mark is detected by the reader 25, the relative location of the web in each of the chambers 24, 26 and 28 can then be calculated and captured parameters recorded and associated with the cells in the chamber.

As shown in FIGS. 2A and 2B, the web 20 can be routed through multiple different chambers or devices at a time using the roll-to-roll system 200A as shown in FIG. 2A or the web 20 can be moved roll-by-roll through each of the devices individually using the system 200B as shown in FIG. 2B. In either case, the web is preferably marked and read as it travels linearly through the devices so that parameters can be continuously captured and correlated with devices being fabricated on the web.

As will be discussed in greater detail hereinbelow, the location and content of the marks on the web 20 will be selected so as to provide both an indication of the linear location of the web that is being detected and also of the lateral positions as well. In the embodiment of FIG. 2B, it will be appreciated that the linear start of the web 20 in the first chamber 24 will be the linear end of the web 20 in the second chamber 26 as the rolls are winding up opposite of how they are winded out. Thus, the marks preferably provide an indication of the absolute position on the web as well as the relative position. It will also be appreciated that the readers 25 may have to be located on opposite sides necessitating duplicate marks in some instances.

It will be appreciated that the foregoing description of the manufacturing of the solar cells is simply examplary and that the actual implementation may vary. Nonetheless, the system is designed to continuously record the various parameters that affect the manufacturing of the solar cells 10 on the web 20 and record these parameters in a manner that identifies the parameters with respect to individual solar cells. As will be described in greater detail below, subsequent processing of the solar cells into arrays, such as stringed together or shingled together groupings of solar cells, also have various manufacturing parameters that can also affect the performance of the solar cells and are also desirably recorded by the database system. Similarly, the packaging of individual cells or arrays of cells into solar panels or modules can also have a variety of different manufacturing and environmental parameters that can affect subsequent performance of the solar panels or module which can also be desirably recorded by the database system 30.

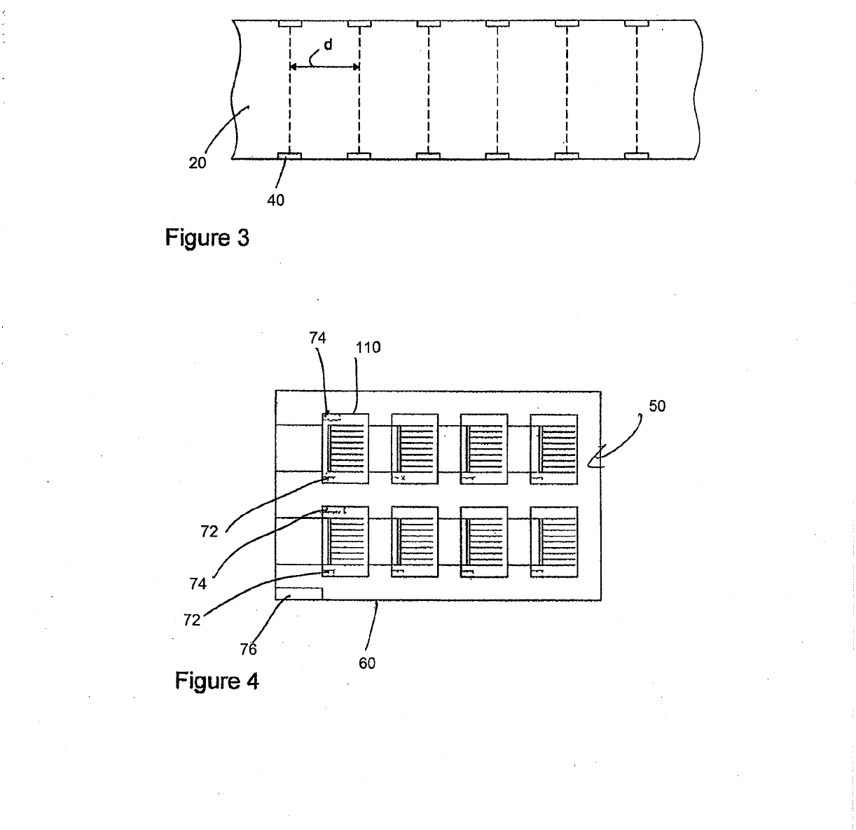

FIG. 3 is a schematic view that illustrates an exemplary manner of marking the web 20 as it travels through the process stations such as various chambers and reactors of the production line 19. It will be understood that the web 20 is continuously travelling through the production line 19 such that linear locations of the web 20 will be exposed to the chambers and reactors sequentially. Thus, if parameters in the chamber and reactors change, different linear portions of the web 20 will be subjected to different conditions during formation of the components of the solar cells. The marking system 32 in this implementation provides marks 40 at discrete intervals ‘d’ along the web 20. These marks 40 are read by the database system 30 and the location of these marks 40 with respect to the various components or process stations of the manufacturing line are correlated so that parameters for the portion of the web 20 in a specific chamber or reactor can be recorded. Thus, cells 10 that are being created at specific linear locations along the web 20, as determined by the marks 40, can thus have parameters recorded for those cells 10 based on the location of the cells 10 as determined with respect to the marks 40.

The marks 40 can comprise bar code marks on the upper or lower surface of the substrate or web 20 or can comprise other types of marks such as laser marking, ink jet marking, stamping, etc. in different locations. It will be apparent that any of a number of different marking systems can be used to identify the location of the web and the corresponding cells that are being created without departing from the scope of the present invention. The objective of marking the web 20 during manufacturing is to correlate the observed manufacturing parameters of the production line to the location of the web 20 upon which a cell is being formed under those parameters so that these cells can be recorded as having those parameters in the database system 30.

Once the solar cells 10 are formed on the web 20, the solar cells 10 are then separated and formed into arrays 50 and panels 60. Generally, the cells 10 are cut from the web 20 into individual cells 10 and are then coupled to adjacent cells 10 into arrays 50 via well known processes such as stringing or shingling. Typically, the cells 10 are arranged in series so that the cells 10 produce an aggregate voltage or current in response to sunlight impinging upon the cells to thereby allow the panels to produce electricity. It will be appreciated that even after formation of the cells 10, significant additional processing steps are needed prior to forming arrays. For example, the cells 10 have to be packaged so that the solar cell is interposed between front and back sheets and laminates and is sealed at the edges. Further, wiring and junction boxes are also attached to the packaged cells so that cells 10 can be electrically interconnected. Preferably, all of the parameters relating to these additional processing steps are also recorded in the database system 30 and tied to an identifying marker so that these parameters can be subsequently accessed.

It will be appreciated that various parameters associated with the formation of arrays 50 may also affect the performance of the solar panel 60. For example, the type of interconnection between adjacent cells 10, e.g., shingling versus stringing, the components used to interconnect adjacent cells 10 into an array, e.g., the wire type and size, etc., are all parameters that may affect the overall performance of the panel 60. Thus, it is desirable to be able to capture this data into the database system for future reference.

Similarly, the various parameters associated with the formation of the arrays 50 into a panel 60 may also result in variations of long term performance characteristics of the panel 60. Thus it is also desirable for the database system to also record parameters associated with panel formation. These parameters may include the mounting structure to which the arrays are attached, the manner in which the arrays 50 are mounted to the mounting structure, the formulation of any coatings that are applied to the arrays 50 after mounting on the mounting structure, etc. Preferably, each of these parameters will also be recorded by the database system 30 during the manufacturing process.

Of course, recording parameters about cells, 10, arrays 50 and panels 60 requires that each of the cells 10, arrays 50 and panels 60 be identifiable. FIG. 4 is one exemplary method of providing identifiers such as bar codes and the like for the cells 10, arrays 50 and panels 60. As shown, on a finished panel 60, each of the cells includes an identifier 72 that identifies the particular solar cell 10 in question. Each of the arrays includes an identifier 74 that identifies the particular array in question and each of the panels 60 includes an identifier 76 that identifies the panel in question.

Preferably, each of the parameters noted above are recorded by the database system 30 for each of the identified cells 10, arrays 50 and panels 60. Thus, when a particular panel 60 is observed over time to have a particular performance characteristic, e.g., a cell 10 is failing or an array 50 is providing less than optimum output, the parameters of the part in question can be accessed via the database system and the parameters can be evaluated to determine if some corrective action is necessary or to determine if a parameter should be changed in future production runs to optimize performance.

In one specific implementation, the identification marker initiates with a marker on the web 20. In this implementation, there is a roll ID marker that identifies the roll. There is also index ID numbers that indicate the location along the length of the web and also potentially a cross-web index indicating the lateral location of the web. The database system 30 records this information and correlates the web location information with observed parameters in the production line 19. When the cells 10 are separated from the web 20, the web location information is then transformed into cell identification information such that the parameters for a particular web location are thus recorded in the database system 30 as parameters for particular cells 10.

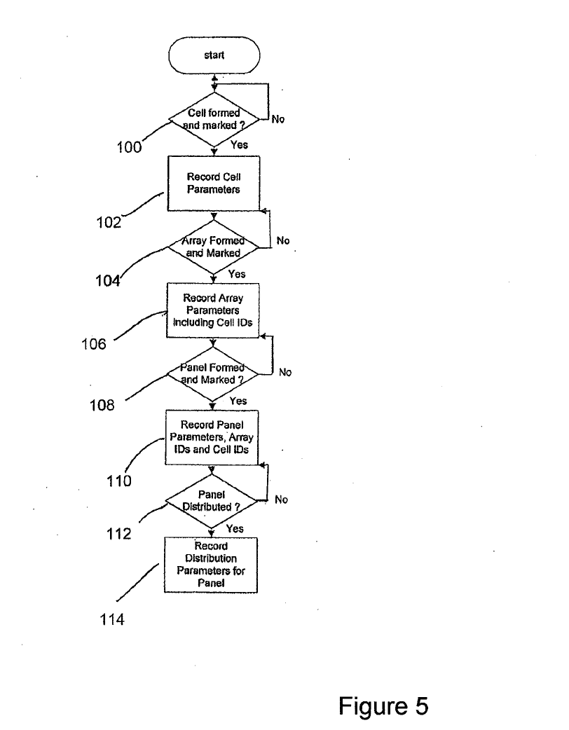

FIG. 5 is an exemplary flow chart that illustrates the one possible operation of the database system 30 as it captures parameters of the cells 10, arrays 50 and panels 60 as they are manufactured and also optionally distributed. As shown, the database system 30 performs a process whereby it determines when a cell 10 has been formed and marked with an identifier in decision state 100 and then records all the captured parameters relating to the cell in the memory in state 102. Preferably these parameters are recorded in a manner that correlates the parameter to the identifier of the cell in the manner described above. Preferably, this step is performed for each and every cell that is being manufactured.

Subsequently, the database system 30 determines if the array has been formed in decision state 104 and if it the array has been formed, it records the array identifiers 74 as well as the parameters associated with forming the array 50, plus the cell identifiers 72 that comprise the array in state 106. In this way, the specific parameters specific to the array 50, e.g., how the array of cells are interconnected, the environmental factors that existed during the interconnection of the cells, etc. are recorded along with the cell identifiers 72 which allows for easy subsequent access to the cell parameters 72 via the array 50.

Subsequently, the database system 30 determines if the panel 60 has been formed and marked, in decision state 108, and if it has been formed and marked with an identifier 76, the panel parameters are then recorded in state 110 along with the identification information of the arrays 50 and also the cells 10 that form the panel. In this way, once the panel 60 is identified, the parameters that are specific to the panel can be retrieved as well as the identification information of the various arrays 50 and cells 60 which allows for subsequent parameter information retrieval of the arrays and cells as well.

Subsequently, it may be desirable to record distribution information in the database system 30 determining, in decision state 112, that panels 60 have been distributed. This information that may be recorded, in state 114, may include the physical location of the panels, mounting information, etc. that may also provide some information as to the future performance of the panels 60 that can be used for subsequent evaluation of panels for future manufacturing optimization. This information may also be used to recall, repair or otherwise alter panels, arrays and cells based on observed characteristics of panels, arrays and cells in other locations that have similar characteristics.

Preferably, the database system records the data in a relational database-type structure such that different components of a panel can be searched via the component ID or alternatively can be searched via a particular parameter. In this way, records for specific components can be retrieved for evaluation purposes and components having similar parameters can also be identified via searching for the parameter in question.

Although the foregoing has shown, illustrated and described one or more implementations of the present invention, it will be appreciated that various substitutions, modifications and changes in the form or use thereof may be made by those skilled in the art without departing from the scope of the present invention. Hence, the scope of the present invention should not be limited to the foregoing discussion, but should be defined by the appended claims.

What is claimed is:

1. A method of manufacturing a solar cell comprising:
forming an absorber layer of the solar cell on a substrate;
recording parameters about the forming of the absorber layer in an electronic memory device;
forming a transmissive layer on the absorber layer;
recording parameters about the forming of the transmissive layer in the electronic memory device;
marking the solar cell with identification information; and
correlating the recorded parameters with the identification information in the electronic memory device such that the identification information can be used to subsequently electronically retrieve the recorded parameters from the electronic memory device.

2. The method of claim 1, wherein fabricating an absorber layer comprises depositing a precursor layer and then reacting the precursor layer in a reactor.

3. The method of claim 2, wherein depositing a precursor layer comprises depositing a thin film material including Cu, In, Ga and Se onto the substrate and wherein reacting the precursor layer comprises reacting the thin film material with S or Se in a high temperature annealing process to form the absorber layer.

4. The method of claim 2, wherein recording the parameters of the fabrication of the absorber layer in the electronic memory device comprises recording at least one of the composition and quantity of material deposited as the precursor layer, the thickness of the precursor layer, the temperature of the annealing chamber, the quantity and type of gas in the annealing chamber.

5. The method of claim 1, wherein fabricating a transmissive layer comprises depositing a transparent window layer on the absorber layer and wherein recording parameters about the fabrication of the transmissive layer comprises recording the materials, thicknesses and environmental factors occurring during the deposition of the transparent window layer on the absorber layer.

6. The method of claim 5, wherein fabricating a transmissive layer comprises depositing a transparent window layer comprised of at least one selected from a CdS film, a ZnO film or a CdS/ZnO film.

7. The method of claim 1, wherein marking the solar cell comprises printing a bar code on the solar cell so that the solar cell is uniquely identified.

8. A method of manufacturing solar cell panels comprising:
manufacturing a plurality of solar cells;
assigning identification information to each of the plurality of solar cells;
recording solar cell parameters in an electronic memory so that the parameters for a particular solar cell are retrievable by the identification information;
interconnecting at least some of the plurality of solar cells into one or more arrays of solar cells;
assigning identification information to each of the arrays of solar cells;
recording array parameters in an electronic memory so that the parameters for a particular array are retrievable by the identification information of the array of solar cells and so that the identification information and parameters of the solar cells comprising the array is retrievable from the electronic memory;
mounting one or more array of solar cells onto one or more panels so as to create solar panels;
assigning identification information to the solar cell panels;
recording solar panel parameters in the electronic memory so that the parameters for a particular solar panel are retrievable by the identification information about the solar cell panel and so that the identification information and parameters about the arrays and the solar cells of the arrays is retrievable from the electronic memory.

9. The method of claim 8, further comprising recording distribution parameters of the solar cell panels in the electronic memory so that the distribution parameters are retrievable by the identification information about the solar cell panel.

10. The method of claim 8, wherein manufacturing the plurality of solar cells comprises:
fabricating an absorber layer on a continuous substrate;
recording parameters about the fabrication of the absorber layer in the electronic memory device;
fabricating a transmissive layer on the absorber layer;
recording parameters about the fabrication of the transmissive layer in the electronic memory.

11. The method of claim 10, wherein fabricating an absorber layer comprises depositing a precursor layer and then reacting the precursor layer in a reactor.

12. The method of claim 11, wherein depositing a precursor layer comprises depositing a thin film material including Cu, In, Ga and Se onto the substrate and wherein reacting the precursor layer comprises reacting the thin film material with S or Se in a high temperature annealing process to form the absorber layer.

13. The method of claim 12, wherein recording the parameters of the fabrication of the absorber layer in the electronic memory device comprises recording at least one of the composition and quantity of material deposited as the precursor layer, the thickness of the precursor layer, the temperature of the annealing chamber, the quantity and type of gas in the annealing chamber.

14. The method of claim 10, wherein fabricating a transmissive layer comprises depositing a transparent window layer on the absorber layer and wherein recording parameters about the fabrication of the transmissive layer in the electronic memory device comprises recording the materials, thicknesses and environmental factors occurring during the deposition of the transparent window layer on the absorber layer.

15. The method of claim 14, wherein fabricating a transmissive layer comprises depositing a transparent window layer comprised of at least one selected from a CdS film, a ZnO film or a CdS/ZnO film.

16. The method of claim 8, further comprising marking the solar cells, the arrays and the solar panel by printing identifiers adjacent the solar cells, arrays and panels so that the solar cells, arrays and panels are uniquely identified and the identifiers indicates the identification information for the solar cells, the arrays and the panels in the electronic memory.

17. The method of claim 8, wherein manufacturing the plurality of solar cells comprises manufacturing the plurality of solar cells on a web that runs through one or more processing devices that form the solar cells.

18. The method of claim 17, wherein assigning identification information to the plurality of solar cells comprise marking the web at discrete intervals along the web with unique identification information.

19. The method of claim 18, wherein recording solar cell parameters in the electronic memory comprises:
recording manufacturing parameters of the solar cells based upon the location of the identification information along the web;
determining the location of the solar cell along the web; and
associating manufacturing parameters with the solar cell based upon the location of the solar cell on the web as determined by the identification information formed along the web.

20. The method of claim 19, wherein determining the location of the solar cell along the web comprises determining the linear location of a mark along the web;
correlating the linear location of the solar cell on web to the determined linear location of the mark along the web;
associating manufacturing parameters of devices to specific solar cells when the linear location of the solar cell on the web as correlated to the mark indicates the solar cell is positioned inside specific device.

21. A method of roll-to-roll forming a plurality of thin films on a continuous flexible substrate to manufacture solar cells and identifying each manufactured solar cell, comprising:
marking a region of the continuous flexible substrate with at least one identification mark, wherein the at least one identification mark includes an information about the location of the region;
forming a solar cell structure over the continuous flexible substrate including the region while the continuous flexible substrate is advanced through at least one process station;
continuously detecting process information from the region as the solar cell structure is formed over the continuous flexible substrate including the region and as it is advanced; and
data processing the process information in an electronic data-base station, the data processing comprising storing the process information detected from the region in the electronic database, correlating the process information from the region to the at least one identification mark.

22. The method of claim 21 further comprising forming a plurality of solar cells by cutting the continuous flexible substrate and the solar cell structure formed on top of the continuous flexible substrate including the region.

23. The method of claim 22 further comprising marking each solar cell from the region with a solar cell identification mark, storing the solar cell identification marks in the electronic data-base and correlating each solar cell identification mark to the at least one identification mark in the data-base and thereby the process information from the region.

24. The method of claim 23 further comprising forming a plurality of solar cell strings by interconnecting the plurality of solar cells with the solar cell identification number.

25. The method of claim 24 further comprising obtaining string manufacturing information and storing it in the electronic data-base.

26. The method of claim 25 further comprising marking each solar cell string with a string identification mark, storing the string identification marks in the electronic data-base and correlating each string identification mark to both its string manufacturing information and the solar cell identification numbers of its solar cells in the data-base.

27. The method of claim 26 further comprising forming a plurality of solar panels using the solar cell strings with string identification marks.

28. The method of claim 27 further comprising obtaining panel manufacturing information and storing it in the electronic data-base.

29. The method of claim 28 further comprising marking each solar panel with a panel identification mark, storing the panel identification marks in the electronic data-base and correlating each solar panel identification mark to both its panel manufacturing information and the solar cell identification numbers of its solar cells in the data-base.

30. The method of claim 21, wherein the steps of continuously detecting and data processing occur simultaneously.

31. The method of claim 21 further comprising the step of reading the at least one identification mark before the step of data processing.

32. The method of claim 21, wherein the step of marking the region includes marking a plurality of sections of the region ordered along the length of the continuous flexible substrate with a plurality of identification marks, wherein each of the identification marks corresponds to its assigned section along the continuous flexible substrate, and wherein the step of data processing the process information includes storing the process information from each section of the region in the electronic database and correlating the process information from each section to its corresponding identification mark.

33. The method of claim 32, wherein the region is the entire surface of the flexible continuous substrate on which the solar cell structure is formed.

34. The method of claim 32 further comprising forming a plurality of solar cells by cutting each section and the solar cell structure formed on top of it.

35. The method of claim 34 further comprising marking the solar cells from the same section with the same solar cell identification mark and thereby forming a plurality of groups of solar cell identification marks from the plurality of sections, storing the solar cell identification marks in the electronic data-base and correlating each solar cell identification mark to the identification mark of the corresponding section in the data-base and thereby the process information from the corresponding section.

36. The method of claim 35 further comprising forming a plurality of solar cell strings by interconnecting the plurality of solar cells from at least one section.

37. The method of claim 36 further comprising obtaining string manufacturing information and storing it in the electronic data-base.

38. The method of claim 37 further comprising marking each solar cell string with a string identification mark, storing the string identification marks in the electronic data-base and correlating each string identification mark to both its string manufacturing information and the solar cell identification numbers of its solar cells in the data-base.

39. The method of claim 38 further comprising forming a plurality of solar panels using the solar cell strings with the string identification number.

40. The method of claim 39 further comprising obtaining panel manufacturing information and storing it in the electronic data-base.

41. The method of claim 40 further comprising marking each solar panel with a panel identification mark, storing the panel identification marks in the electronic data-base and correlating each panel identification mark to both its panel manufacturing information and the solar cell identification numbers of its solar cells in the data-base.

42. The method of claim 32 further comprising the step of reading each section identification mark before the step of data processing the information.

43. The method of claim 32, wherein the sections are discrete and in a sequential order along the continuous flexible substrate.

44. The method of claim 29, wherein the identification marks, solar cell identification marks, string identification marks and panel identification marks include at least one of barcodes and alphanumeric characters.

45. The method of claim 21, wherein the process information includes process parameters used to manufacture solar cell structure.

46. The method of claim 45, wherein the process parameters includes process temperatures, material compositions, thickness measurements, optical measurements of different materials, gas pressures and deposition related data.

47. The method of claim 46, wherein the deposition related data includes electrodeposition currents, electrodeposition solutions and electrodeposition time.
